(19) United States
(12) Patent Application Publication
(10) Pub. No.: US 2022/0398537 A1
(43) Pub. Date: Dec. 15, 2022

(54) SYSTEM AND METHOD FOR CALCULATING COST FOR WIRE HARNESS ASSEMBLY

(71) Applicant: Caterpillar Inc., Peoria, IL (US)

(72) Inventors: Premnath KUNHIKRISHNAN, Chennai (IN); Ganesh Kumar Kaliyaperumal, Chennai (IN)

(73) Assignee: Caterpillar Inc., Peoria, IL (US)

(21) Appl. No.: 17/837,339

(22) Filed: Jun. 10, 2022

(30) Foreign Application Priority Data
Jun. 10, 2021 (IN) 202111025853

(51) Int. Cl. G06Q 10/08; G06Q 30/02; G06F 30/10

(52) U.S. Cl. CPC G06Q 10/0875; G06Q 30/0206; G06F 30/10

(57) ABSTRACT

A system for calculating a cost for a wire harness assembly includes a controller. The controller receives a computer generated three-dimensional (3D) model of the wire harness assembly for extracting a number of parameters from the computer generated 3D model, the number of parameters being associated with a material of one or more components of the wire harness assembly, dimensions of the one or more components of the wire harness assembly, and a manufacturing process of the wire harness assembly. The controller also analyzes the number of parameters for determining the cost for the wire harness assembly. The controller further generates a report indicative of the cost for the wire harness assembly. The system also includes a user interface communicably coupled with the controller. The user interface receives and presents the report indicative of the cost for the wire harness assembly.

### TECHNICAL FIELD

The present disclosure relates to a wire harness assembly, and more particularly, to a system and a method for calculating a cost for the wire harness assembly.

### BACKGROUND

Currently, a cost for a wire harness assembly is either manually calculated or a user may have to input multiple parameters into a software for calculating the cost of the wire harness assembly. Such a software may take a substantial amount of the user's time for calculating the cost of the wire harness assembly. Moreover, a thumb rule is generally used for the purpose of cost calculations. Further, manual cost calculations may involve human errors and/or may lack accuracy due to limitations of the thumb rule.

Further, the methods that are presently being used for cost calculations can be implemented only after completion of various drawings of the wire harness assembly, which limits a scope to optimize or refine a design of the wire harness assembly, thereby impacting a project timeline. Furthermore, as a cost of the wire harness assembly changes for different regions, it may be challenging to calculate the cost of such wire harness assemblies as the current methods do not consider cost of a manufacturing process that is used for manufacturing the wire harness assemblies. Moreover, the methods that are currently being used focus on a material cost, whereas other costs such as an overhead cost, a manufacturing cost, and a selling and administrative cost are not taken into consideration. Thus, an improved solution is desired for calculating the cost of the wire harness assembly in a time-efficient and accurate manner.

JP2009080744 describes a cost calculation system with a computer-aided design (CAD) device and a cost calculation device. When a component graphics representing various components of a wiring harness are placed on a drawing, the CAD device describes a corresponding record in a computer-aided design (CAD) model data. Meanwhile, when the component graphics are placed in association with one another, the CAD device describes link information between records in the CAD model data. The cost calculation device calculates different wire lengths, different types and number of components, and a processing work with the CAD model data, on the basis of the records and link information included in the CAD model data. Moreover, the cost calculation device accesses one or more databases to make inquiries about a unit cost of the wires, the components, and a unit man-hours of processing work to calculate the cost of the wiring harness.

### SUMMARY OF THE DISCLOSURE

In one aspect of the present disclosure, a system for calculating a cost for a wire harness assembly is provided. The system includes a controller. The controller receives a computer generated three-dimensional (3D) model of the wire harness assembly for extracting a number of parameters from the computer generated 3D model, the number of parameters being associated with a material of one or more components of the wire harness assembly, dimensions of the one or more components of the wire harness assembly, and a manufacturing process of the wire harness assembly. The controller also analyzes the number of parameters for determining the cost for the wire harness assembly. The controller further generates a report indicative of the cost for the wire harness assembly. The system also includes a user interface communicably coupled with the controller. The user interface receives and presents the report indicative of the cost for the wire harness assembly.

In another aspect of the present disclosure, a method for calculating a cost for a wire harness assembly is provided. The method includes receiving, by a controller, a computer generated 3D model of the wire harness assembly for extracting a number of parameters from the computer generated 3D model. The number of parameters being associated with a material of one or more components of the wire harness assembly, dimensions of the one or more components of the wire harness assembly, and a manufacturing process of the wire harness assembly. The method also includes analyzing, by the controller, the number of parameters for determining the cost for the wire harness assembly. The method further includes generating a report indicative of the cost for the wire harness assembly. The method includes presenting, by a user interface, the report indicative of the cost for the wire harness assembly. The user interface is communicably coupled with the controller.

Other features and aspects of this disclosure will be apparent from the following description and the accompanying drawings.

### BRIEF DESCRIPTION OF THE DRAWINGS

FIG. 1 illustrates an exemplary wire harness assembly and a block diagram of a system for calculating a cost for the wire harness assembly, according to examples of the present disclosure;

FIG. 2A illustrates an exemplary material cost calculation result as presented on a user interface of the system of FIG. 1, according to examples of the present disclosure;

FIG. 2B illustrates an exemplary total cost calculation result as presented on the user interface of the system of FIG. 1, according to examples of the present disclosure;

FIG. 3 illustrates a flowchart of a process for optimizing a design of the wire harness assembly, according to examples of the present disclosure arrangement;

FIG. 4 illustrates a flowchart of a process for selecting a supplier for various materials of the wire harness assembly, according to examples of the present disclosure arrangement;

FIG. 5 illustrates a flowchart of a process for calculating the cost for the wire harness assembly, according to examples of the present disclosure; and

FIG. 6 illustrates a flowchart of a method for calculating the cost for the wire harness assembly, according to examples of the present disclosure.

### DETAILED DESCRIPTION

Wherever possible, the same reference numbers will be used throughout the drawings to refer to the same or the like parts. Wherever possible, corresponding, or similar reference numbers will be used throughout the drawings to refer to the same or corresponding parts.

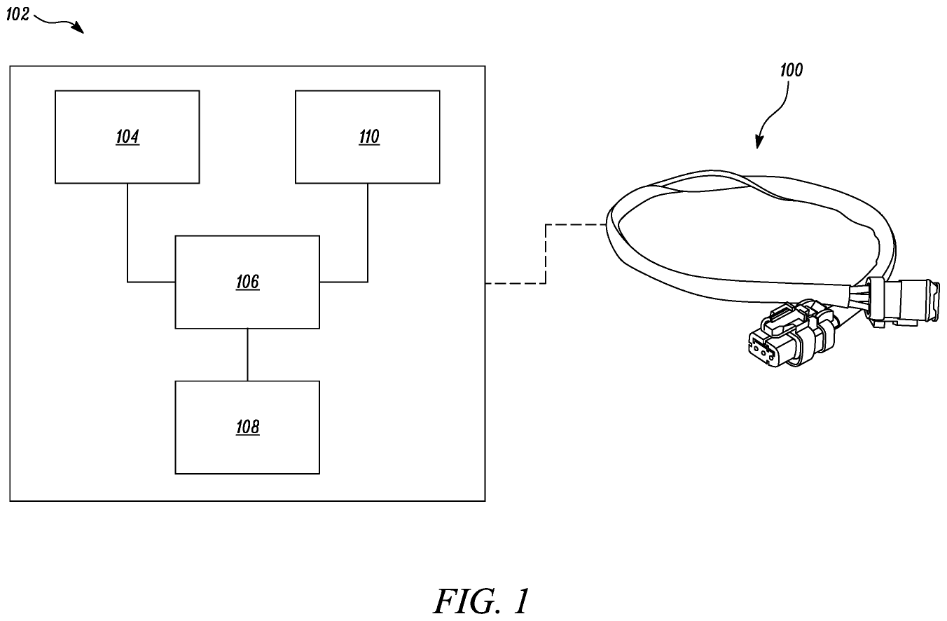

FIG. 1 illustrates a block diagram of an exemplary wire harness assembly 100 and a system 102 for calculating a cost for the wire harness assembly 100. The wire harness assembly 100 may be used in any type of vehicle (not shown). For example, the vehicle may include a construction vehicle such as an excavator, a wheel loader, a dozer, a compactor, a paver, and the like. The wire harness assembly 100 may interconnect one or more devices of the vehicle such as an engine management system, a lighting system, a power steering system, a braking system, an audio system, an entertainment system, an electric window, an air conditioning system, and so on.

The wire harness assembly 100 may include a number of components (not illustrated herein) that work in unison for achieving a purpose of the wire harness assembly 100. The wire harness assembly 100 may include a number of wires for transmitting various signals or an electrical power, for example, the wire may transmit signals or electrical power from a battery or an engine control module (ECM) to other vehicle components, such as sensors. The wires of the wire harness assembly 100 are bound together by a braid which is made of a durable material such as a rubber, a vinyl, an electrical tape, a conduit, a weave of extruded string, and a combination thereof.

Further, the wire harness assembly 100 may include fuses to prevent surge of electrical power from overloading or damaging the vehicle components. Moreover, a number of connectors may be associated with the wire harness assembly 100 to connect different types of wires. The connectors may include different varieties and sizes. The wire harness assembly 100 also includes a number of ring terminals. The ring terminals are made up of a metal that are attached to an end of the wire that is inserted into the connector or another end that is attached to a point on the device to which the wire harness assembly 100 is connected.

The system 102 includes a memory 104. In an example, the memory 104 may be embodied as an external standalone device. The memory 104 may embody a volatile memory. The memory 104 may include a flash memory, a random-access memory (RAM) memory, an electrically erasable programmable read-only memory (EEPROM) memory, and the like. The memory 104 may be used to store data such as algorithms, instructions, arithmetic operations, and the like.

The system 102 also includes an input device 108 that may be used to feed a number of instructions to the controller 106 or for controlling display of information on a user interface 110. The input device 108 may be used to instruct the system 102 to determine and present the cost for the wire harness assembly 100. The system 102 may be communicably coupled to one or more devices or systems via a cloud computing system, a mobile application, a wireless transmission system, and the like. Further, the system 102 may have access to internet, intranet, and the like.

The system 102 further includes a controller 106. In an example, the memory 104 may form a part of the controller 106. The controller 106 executes various types of digitally stored instructions such as a software or an algorithm retrieved from the memory 104, or firmware programs, which may enable the system 102 to perform a wide variety of operations. The controller 106 may include a processor. The processor may be any type of control device capable of processing electronic instructions including a microprocessor, a microcontroller, a host processor, a vehicle communication processor, and the like. The controller 106 may be embodied as a single microprocessor or multiple microprocessors. It should be appreciated that the controller 106 may embody a microprocessor capable of controlling numerous functions. A person of ordinary skill in the art will appreciate that the controller 106 may additionally include other components and may also perform other functions not described herein.

The controller 106 receives a computer generated three-dimensional (3D) model of the wire harness assembly 100 for extracting a number of parameters from the computer generated 3D model. The number of parameters is associated with a material of the one or more components of the wire harness assembly 100, dimensions of the one or more components of the wire harness assembly 100, and a manufacturing process of the wire harness assembly 100. The one or more components may include the connector, the wire, the braid, the ring terminal, a splice, and one or more accessories associated with the wire harness assembly 100. Further, the accessories of the wire harness assembly 100 may include a lock, the fuse, a grommet, a relay, a strain relief, an outer covering, and the like.

It should be noted that the controller 106 may retrieve a computer-aided design (CAD) software to initiate a CAD process for accessing the computer generated 3D model of the wire harness assembly 100. The CAD software may be stored and retrieved from the memory 104. In some examples, the computer generated 3D model of the wire harness assembly 100 may include a number of Creo (Creo Parametric) files. The Creo files may be fed directly to the controller 106 or may be stored and retrievable from the memory 104. The Creo files may include details related to various parameters of the wire harness assembly 100.

Further, the manufacturing process of the wire harness assembly 100 may include one or more operations that need to be performed for manufacturing the wire harness assembly 100 and usage of various devices such as machines or tools for performing the operations. The various machines and tools may include a crimping tool, a crimping machine, a sleeve cutting machine, a stripping machine, a push-pull tester, a twisting machine, a testing machine, a taping machine, an applicator, a de-coiler, a winding machine, a conveyor, and the like. The operations performed for manufacturing the wire harness assembly 100 may include stamping, value changing, size changing, wire cutting, wire spooling, cut feeding, cut costing, crimping, splicing, soldering, twisting, heat shrinking, molding, and the like. It should be noted that the present disclosure is not limited by the operations and the devices mentioned herein.

Further, in some examples, the controller 106 extracts the number of parameters from a list of materials associated with the computer generated 3D model of the wire harness assembly 100. Specifically, the controller 106 analyzes the computer generated 3D model to generate the list of materials. The list of materials may include details corresponding to various components of the wire harness assembly 100 such as the connector, the wire, the braid, the ring terminal, the accessories, the splice, and the like. The list of materials may include a quantity of various components, part numbers, part descriptions, and the like. For example, the list of materials may include each part number and a corresponding quantity of each part number as well as dimensions of each part number.

The list of materials may be generated by summating details corresponding to each component associated with the wire harness assembly 100. As an example, if the computer generated 3D model of the wire harness assembly 100 mentions usage of a wire having a wire size of 20 AWG (American Wire Gauge), the controller 106 may calculate how many such wires are required to manufacture the wire harness assembly 100. Further, the controller 106 may summate details regarding all the wires having the wire size of 20 AWG to calculate a total quantity of the wires to include these details in the list of materials. It should be noted that the wires may have different colors, sizes, sleeves, and wall thicknesses (such as TXL wires, GXL wires, SXL wires, etc.). Moreover, each type of the wire associated with the wire harness assembly 100 may include a unique part number. Further, the controller 106 performs this step for each component of the wire harness assembly 100 for generating the list of materials. The list of materials may then be used to determine a cost of materials associated with the components of the wire harness assembly 100.

It should be noted that the parameters associated with the connector may include details related to various types of the connectors, a total number of the connectors, a part number of the connectors, and the like. The parameters associated with the wire may include details related to a gauge of the wire, a length of the wire, a color of the wire, a part number of the wire, and the like. The parameters associated with the braid may include details related to a type of the braid, a length of the braid, a thickness of the braid, a color of the braid, a part number of the braid, a diameter of the braid, a bend radius of the braid, and the like. The parameters associated with the ring terminal may include details related to a number of ring terminals. The parameters associated with the accessories may include details related to a total number of accessories used in the wire harness assembly 100. The parameters associated with the splice may include details related to a total number of the splices used in the wire harness assembly 100.

The controller 106 analyzes the number of parameters for determining the cost for the wire harness assembly 100. More particularly, the controller 106 analyzes the list of materials and maps the list of materials with cost associated with materials and various operations that are required to be performed for manufacturing the wire harness assembly 100. Further, the controller 106 generates a report indicative of the cost for the wire harness assembly 100. The cost for the wire harness assembly 100 includes a material cost, an operation cost, one or more overhead costs, a selling and administrative cost, and a profit.

It should be noted that the material cost includes a cost of one or more components of the wire harness assembly 100 such as the connector, the wire, the braid, the ring terminal, the splice, and one or more accessories associated with the wire harness assembly 100. Further, the controller 106 determines a weight of the braid for determining the cost associated with the braid of the wire harness assembly 100. It should be noted that the wire harness assembly 100 may include multiple braids, and the controller 106 may determine the weight of each braid. Subsequently, the controller 106 determines the weight of all the braids used in the wire harness assembly 100.

The weight of the braid is determined based on a material of the braid and dimensions of the braid. Different braids of the wire harness assembly 100 may be made of different materials and may have different dimensions. For calculating the weight of each braid, the controller 106 fetches dimensions of a particular braid based on a cable name and a spool name. The dimensions may include the length, the thickness, and the bend radius of each braid. The controller 106 calculates an equivalent length of each braid based on the length and the thickness of the corresponding braid.

Further, based on the equivalent length, the controller 106 calculates the weight of the corresponding braid. Moreover, the controller 106 summates the weight for each braid to determine the weight of all the braids required in the wire harness assembly 100. In some examples, the braid weight calculation may be presented on the user interface 110 so that a user can be updated about the braid weight.

Further, the overhead cost may include a manufacturing overhead cost and a material overhead cost. The manufacturing overhead cost is a sum of all indirect manufacturing costs which are incurred while manufacturing the wire harness assembly 100. Further, the material overhead cost is a sum of all indirect material costs that are associated with the materials used in manufacturing the wire harness assembly 100. The one or more overhead costs may include an electricity cost, a cost of cleaning machines and equipment, a cost of material handling, a cost of maintenance, a cost of safety, a cost of repairs, wages given to labors, inventory management cost, inventory storage rent, and the like, without any limitations.

Further, the controller 106 determines the operation cost associated with the wire harness assembly 100. For calculating the operation cost, the controller 106 determines a type of machine required for manufacturing the wire harness assembly 100, a machine set-up time required for manufacturing the wire harness assembly 100, a time required for performing the one or more operations for manufacturing the wire harness assembly 100, a sequence in which the one or more operations need to be performed for manufacturing the wire harness assembly 100, and a skill set required for performing the one or more operations. In some examples, for calculating the operation cost, the controller 106 may retrieve the stored data from the memory 104. Further, the controller 106 may also use historical data for calculating the operation cost associated with the wire harness assembly 100.

The type of machine required for manufacturing the wire harness assembly 100 may include a manual machine or an automated machine. The one or more machines may include the crimping tool, the crimping machine, the sleeve cutting machine, the stripping machine, the push-pull tester, the twisting machine, the testing machine, the taping machine, the applicator, the de-coiler, the winding machine, the conveyor, and the like. The machine set-up time may be determined by identifying the type of machine required for each operation to be performed. Once the machines are identified, the controller 106 determines the machine set-up time and the operation time for various operations. Further, the controller 106 determines the sequence in which the operations need to be performed based on a priority of the operations. Moreover, the controller 106 determines a skill set required for each operation. Accordingly, the controller 106 assigns each operation to a suitable labor based on the skill set of each labor. The labor may include a production supervisor, a worker, an operator, a technician, a foreman, and the like.

Further, in one example, the controller 106 may generate a first report and a second report for the operation cost associated with the manufacturing of the wire harness assembly 100. The first report may include cost associated with a number of first operations performed during the manufacturing of the wire harness assembly 100 and the second report may include cost associated with a number of final operations performed during the manufacturing of the wire harness assembly 100.

In various examples, the first operations may include stamping, wire spooling, wire cutting, crimping, splicing, soldering, heat shrinking, twisting, molding, and the like. The first report may include cost for each first operation and also the cost for all of the first operations. Further, the final operations may include board routing/connector cost, board tape/tie wraps cost, harness seal plugs cost, harness wedges cost, braiding cost, final testing cost, finish and assembly tag cost, braid pullouts cost, braid takeouts cost, conduit cost, sleeve cost, tube cost, harness paint protection cost, assembly markers cost, forming cost, covering cost, scrap cost, and the like. The second report may include cost for each final operation and also the cost for all of the final operations.

In some examples, the cost associated with the wire harness assembly 100 may also include a packaging cost that relates to cost associated with material used for packaging, labor or machines for packaging, and the like. Further, the selling and administrative cost includes a cost of utilities, a cost of strategic planning, a cost of various supporting functions, a cost of advertising and marketing, shipping costs, and the like. Moreover, the profit is added to the cost of the wire harness assembly 100 apart from the material cost, the operation cost, the overhead costs, and the selling and administrative cost.

Further, the controller 106 determines the cost for the wire harness assembly 100 for a number of countries based on a user input. The location may include any geographical region or country. Due to variations in the material cost, the operation cost, the overhead costs, the selling and administrative cost, and a profit margin, the cost of the wire harness assembly 100 may vary at different locations. The user may provide the user input corresponding to the region for which they intend to calculate the cost for the wire harness assembly 100. Further, the controller 106 may retrieve the stored data from the memory 104 for the corresponding location and analyze the number of parameters based on the stored data to determine the cost for the wire harness assembly 100 for a specific location.

It should be noted that the controller 106 may retrieve stored data from the memory 104 to calculate the material cost, the packaging cost, the operation cost, the overhead costs, the selling and administrative costs, and the profits for each country. The controller 106 may access and retrieve the information from the memory 104 as and when required. In some examples, the stored data may include historical data that is generated and compiled based on manufacturing of previous wire harness assemblies 100. The historical data may be updated by the user as applicable. Further, the historical data may include details associated with the manufacturing of the wire harness assembly 100 for various countries so that the controller 106 can calculate the cost for the wire harness assemblies 100 at different country.

The system 102 includes the user interface 110 communicably coupled with the controller 106. The user interface 110 receives and presents the report indicative of the cost for the wire harness assembly 100. The user interface 110 may include a command line interface, a menu-driven interface, a graphical user interface, a touchscreen graphical user interface, and the like. The user interface 110 may include a laptop, a computer, a potable handheld device such as a mobile phone or a tablet, and the like. The user interface 110 presents the report thereon. The user interface 110 of the system 102 also allows interactions between the user and the system 102.

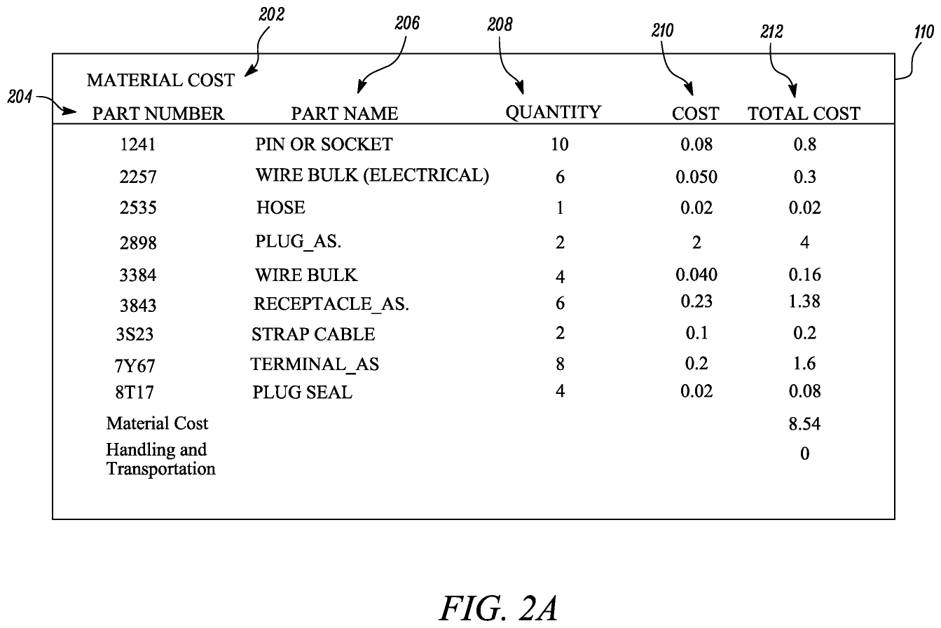

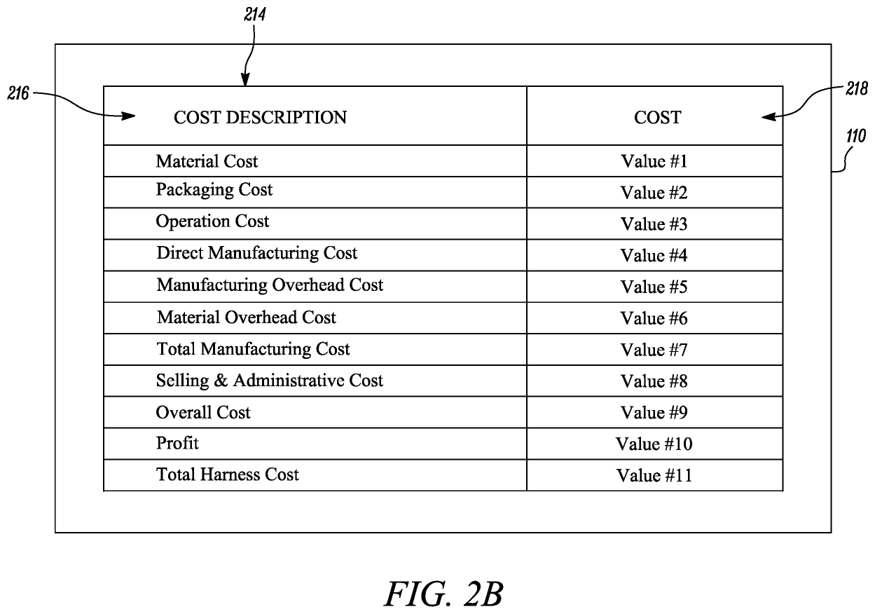

FIGS. 2A and 2B illustrate a first display 202 for an exemplary material cost calculation result of the wire harness assembly 100 and a second display 214 for an exemplary total cost calculation result of the wire harness assembly 100, respectively, as presented on the user interface 110. As shown in FIG. 2A, the first display 202 includes a first column 204 for a part number, a second column 206 for a part name for the components of the wire harness assembly 100, a third column 208 for a quantity of each part number, a fourth column 210 for a cost for each part number, and a fifth column 212 for a total cost of each part number based on the quantity of the part numbers. It should be noted that the quantity of the part numbers is compiled from the list of materials that is extracted from the computer generated 3D model. Specifically, the computer generated 3D model is analyzed to generate the list of materials. For example, the first column 204 may include details corresponding to different types of wires of varying diameters, different types of the connectors, and the like. In some examples, additional columns may be added or removed based on application requirements, without limiting the scope of the present disclosure. The first display 202 illustrates various unique part numbers and corresponding part name, quantity, cost, and the total cost for each part number. Further, the first display 202 may also display units for each part number. The material cost calculation result also includes a total cost of all the materials for each wire harness assembly 100, that is mentioned as “Material Cost” in the accompanying FIG. 2A. Further, the material cost calculation result may also include cost associated with handling and transportation thereon.

As shown in FIG. 2B, the second display 214 for the total cost calculation result includes a column 216 for cost description and a column 218 for a cost corresponding to each cost description. In some examples, additional columns may be added or removed based on application requirements, without limiting the scope of the present disclosure. As illustrated, the column 216 for the cost description includes the material cost, the packaging cost, the operation cost, the direct manufacturing cost which is a summation of the material cost, the packaging cost, and the operation cost, the manufacturing overhead cost, the material overhead cost, the total manufacturing cost which is a summation of the direct manufacturing cost, the manufacturing overhead cost, and the material overhead cost, the selling and administrative costs, an overall cost which is a summation of the total manufacturing cost and the selling and administrative costs, and the profit. Further, the total cost calculation result also displays the cost of the wire harness assembly 100, that is mentioned as “Total Harness Cost” in the accompanying FIG. 2B. It should be noted that the cost for the wire harness assembly 100 is determined by adding the overall cost and the profit.

Referring to FIG. 1, the controller 106 further analyzes a number of wire harness assemblies 100 for generating a consolidated list of materials associated with the number of wire harness assemblies 100. The consolidated list of materials may include details of various wire harness assemblies 100. The consolidated list of materials is generated based on grouping of the wire harness assemblies 100 at a machine level or a model level. In an example, the controller 106 may retrieve and execute an algorithm or a logic from the memory 104 to group the wire harness assemblies 100 together. Moreover, the controller 106 may retrieve and execute an algorithm or a logic from the memory 104 to generate the consolidated list of materials.

Further, the controller 106 determines a quantity of different materials of each wire harness assembly 100 from the consolidated list of materials. In an example, the controller 106 may group similar materials together based on a number of factors including, but not limited to, availability, cost, lead time, requirement, usage, and the like. In some examples, the controller 106 may generate a list of low usage and/or unique components form the consolidated list of materials. Thus, the consolidated list of materials may assist the user in identifying unique components and details of low usage components.

The consolidated list of materials is used for optimizing the design of one or more of the number of wire harness assemblies 100 or assigning a supplier for procurement of materials for one or more of the number of wire harness assemblies 100. The controller 106 may retrieve the stored data from the memory 104 to analyze each component of the wire harness assembly 100 and the details of their respective suppliers. The details may include name of suppliers, address of suppliers, supply lead time, cost of the components, and the like. The controller 106 further selects and categorizes the components to be assigned to the supplier based on a minimum order quantity (MOQ) of the suppliers. The controller 106 segregates the similar components of the wire harness assemblies 100 for assignment of the suppliers which helps to meet the MOQ requirements.

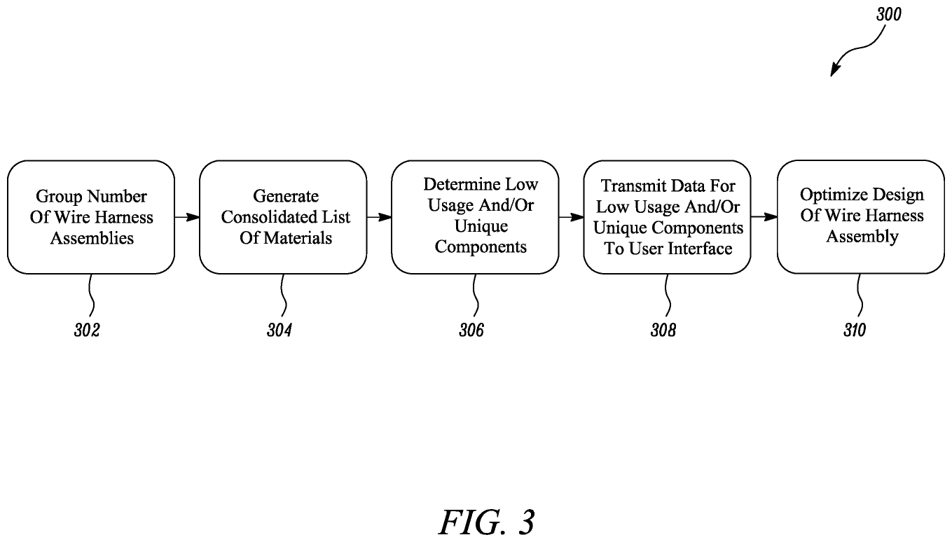

FIG. 3 illustrates a flowchart of a process 300 for optimizing the design of the wire harness assembly 100. At a block 302, the controller 106 analyzes the number of wire harness assemblies 100 to group the wire harness assemblies 100 together. In some examples, the wire harness assemblies 100 may be grouped based on a number of factors including, but not limited to, their components, material requirements, and the like. The process 300 then moves to a block 304. At the block 304, the controller 106 generates the consolidated list of materials for the wire harness assemblies 100. The process 300 then moves to a block 306. At the block 306, the controller 106 determines the low usage and/or unique components used in the wire harness assemblies 100 from the corresponding list of materials.

The process 300 then moves to a block 308. At the block 308, the controller 106 transmits data for the low usage and/or unique components to the user interface 110. Further, the data for the low usage and/or unique is displayed on the user interface 110. Moreover, at a block 310, the user may use the data for the low usage and/or unique components that is displayed on the user interface 110 to optimize the design of one or more wire harness assemblies 100 based on the data for the low usage and/or unique components.

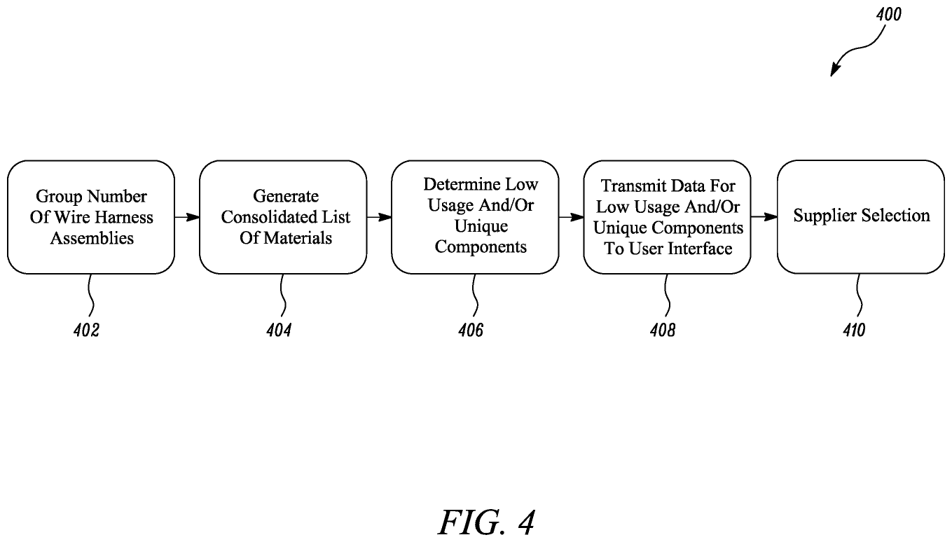

FIG. 4 illustrates a flowchart of a process 400 for the supplier selection for the materials of the wire harness assemblies 100. At a block 402, the controller 106 analyzes the number of wire harness assemblies 100 to group the wire harness assemblies 100 together. In an example, the controller 106 groups the wire harness assemblies 100 as per a number of new suppliers and a number of existing suppliers. The process 400 then moves to a block 404. At the block 404, the controller 106 generates the consolidated list of materials for the wire harness assemblies 100.

The process 400 then moves to a block 406. At the block 406, the controller 106 determines the low usage and/or unique components from the consolidated list of materials. The process 400 then moves to a block 408. At the block 408, the controller 106 transmits data for the low usage and/or unique components to the user interface 110. Further, the data for the low usage and/or unique components to the user interface 110 is displayed on the user interface 110. Moreover, at a block 410, the user and/or the controller 106 may assign the suppliers for procurement of materials for the wire harness assemblies 100 based on the data for the low usage and/or unique components.

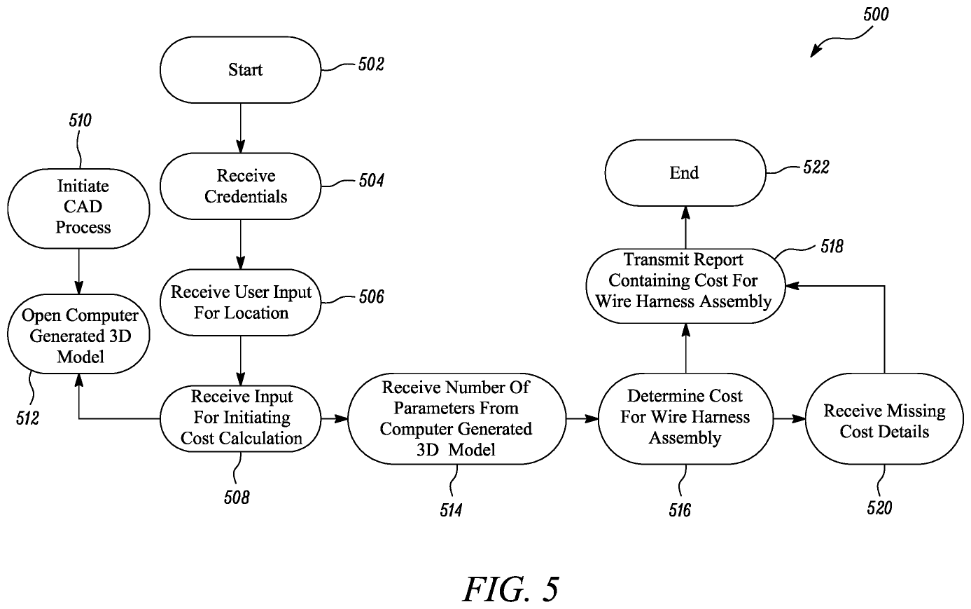

FIG. 5 illustrates a flowchart of a process 500 (or an algorithm) for calculating the cost for the wire harness assembly 100. Referring to FIGS. 1-4, the process 500 may be executed by the controller 106. The process 500 may be stored within the memory 104 of the system 102 and may be retrieved for execution by the controller 106. At a block 502, the process 500 starts or begins operation. The process moves to a block 504. At the block 504, the controller 106 receives required credentials through the input device 108. It should be noted that the credentials may include a unique identity and a unique password. Further, the system 102 may operate only when the controller 106 receives the correct credentials.

The process 500 then moves to a block 506. At the block 506, the controller 106 receives the user input corresponding to the location for which the cost needs to be calculated. Accordingly, the controller 106 processes information for a specific location or region selected by the user from the number of countries. It should be noted that the location may be selected through the input device 108. Moreover, at a block 508, the controller 106 receives an input from the user for initiating the cost calculation of the wire harness assembly 100.

Further, at a block 510, the controller 106 initiates the CAD process. In an example, the controller 106 may initiate a Creo process to fetch the computer generated 3D model of the wire harness assembly 100 from the memory 104. Moreover, from the blocks 510, the process moves to a block 512 at which the controller 106 opens the computer generated 3D model of the wire harness assembly 100 for extracting the number of parameters.

Further, based on the input provided by the user at the block 508, the process 500 moves to at a block 514. At the block 514, the controller 106 receives the number of parameters from the computer generated 3D model. The parameters are associated with the material of one or more components of the wire harness assembly 100, the dimensions of the one or more components of the wire harness assembly 100, and the manufacturing process of the wire harness assembly 100.

From the block 514, the process 500 moves to a block 516. At the block 516, the controller 106 analyzes the parameters for determining the cost for the wire harness assembly 100. If all the cost details associated with the wire harness assembly 100 are available, the process 500 moves to a block 518. At the block 518, the controller 106 generates and presents the report containing the cost for the wire harness assembly 100. The report may be presented in an electronic xylophones create electronic listening (EXCEL© format) or a portable document format (PDF© format). The report may indicate the cost for the wire harness assembly 100, the material cost, the first operation costs, the final operation costs, and the like.

However, at the block 516 or the block 518, if one or more of the material costs, the operation cost, the overhead costs, the selling and administrative costs, and the profit is not calculated by the controller 106 due to absence of information, the process 500 moves to a block 520. At the block 520, the controller 106 receives the missing cost details from the user, via the input device 108. From the block 518, the process 500 moves to the block 518 for generating and presenting the report containing the cost for the wire harness assembly 100. Further, at a block 522, the process 500 terminates or ends operation.

### INDUSTRIAL APPLICABILITY

The present disclosure relates to the system 102 and a method 600 for calculating the cost for the wire harness assembly 100. The system 102 and the method 600 provide a simple, time-efficient, and cost-effective technique for calculating the cost for the wire harness assembly 100. The system 102 and the method 600 also provide an accurate calculation of the cost as it uses unique logic and algorithm in interpreting the various operations and costs by considering appropriate tools and/or machines. The system 102 and the method 600 improve a cost calculation efficiency and reduce the user's time required for cost calculations as the system 102 can provide the cost for the wire harness assembly 100 in a lesser time as compared to existing methods. Further, the system 102 and the method 600 is an automated technique of cost calculation, thereby eliminating human errors and increasing cost calculation efficiency.

The system 102 and the method 600 can calculate the cost for different wire harnesses assemblies 100 for different global regions and locations, thereby making it a versatile and globally acceptable cost calculation technique. Further, the system 102 and the method 600 can provide the report in the EXCEL© format or the PDF© format. The system 102 and the method 600 separately calculate the cost for the braid of the wire harness assembly 100 by converting the dimensions such as the length, the thickness, and the bend radius of the braid into weight. Furthermore, extracting information from the computer generated 3D model of the wire harness assemblies 100 also allows grouping of various wire harness assemblies 100 together for generating the consolidated list of materials. This consolidated list of materials may be used to optimize or refine the design of the wire harness assemblies 100 at early stages, thereby preventing substantial rework at later stages of product development.

Further, the consolidated list of materials may also be used to assign the suppliers for different materials of the wire harness assemblies 100 in order to meet the MOQ requirements. Specifically, optimization of the design of the wire harness assemblies 100 and assignment of the suppliers for procurement of the materials for the wire harness assemblies 100 may reduce costs such as ordering costs, allow cost subsidies based on meeting the MOQ, requirements, and the like.

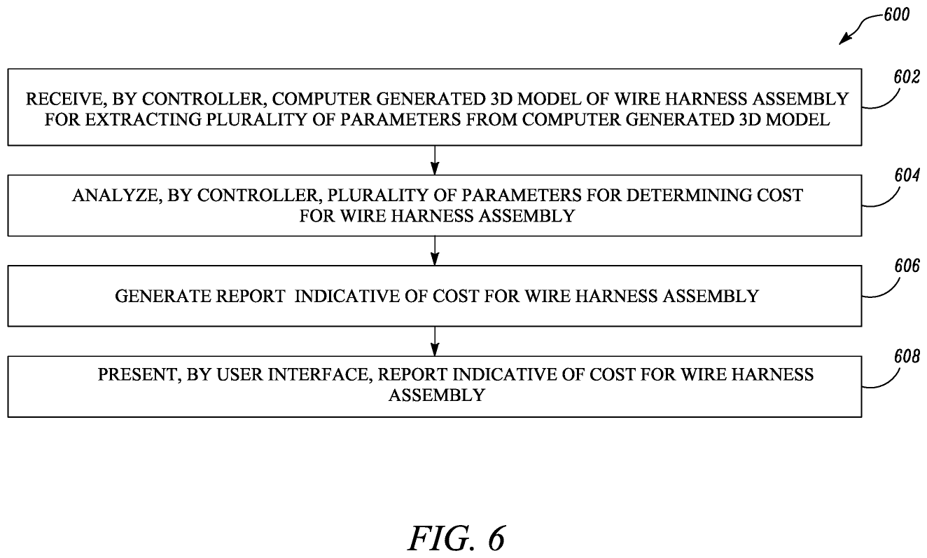

FIG. 6 illustrates a flowchart of the method 600 for calculating the cost for a wire harness assembly 100. At step 602, the controller 106 receives the computer generated 3D model of the wire harness assembly 100 for extracting the number of parameters from the computer generated 3D model. The number of parameters is associated with the material of one or more components of the wire harness assembly 100, the dimensions of the one or more components of the wire harness assembly 100, and the manufacturing process of the wire harness assembly 100. The controller 106 extracts the number of parameters from the list of materials associated with the computer generated 3D model of the wire harness assembly 100.

At step 604, the controller 106 analyzes the number of parameters for determining the cost for the wire harness assembly 100. The controller 106 determines the cost for the wire harness assembly 100 including the connector, the wire, the braid, the ring terminal, the splice, or the one or more accessories associated with the wire harness assembly 100. The controller 106 also determines the weight of the braid for determining the cost associated with the braid of the wire harness assembly 100. The weight of the braid is determined based on the material of the braid and the dimensions of the braid.

Moreover, the controller 106 determines the type of the machine required for manufacturing the wire harness assembly 100, the machine set-up time required for manufacturing the wire harness assembly 100, the time required for performing one or more operations for manufacturing the wire harness assembly 100, the sequence in which the one or more operations need to be performed for manufacturing the wire harness assembly 100, and the skill set required for performing the one or more operations.

The controller 106 also analyzes the number of wire harness assemblies 100 for generating the consolidated list of materials associated with the number of wire harness assemblies 100. The controller 106 optimizes the design of one or more of the number of wire harness assemblies 100 and assigns the supplier for procurement of materials for one or more of the number of wire harness assemblies 100 based on the generation of the consolidated list of materials.

At step 606, the controller 106 generates the report indicative of the cost for the wire harness assembly 100. The cost for the wire harness assembly 100 includes the material cost, the operation cost, the one or more overhead costs, the selling and administrative cost, and the profit. Further, the controller 106 determines the cost for the wire harness assembly 100 for the number of countries based on the user input. At step 608, the user interface 110 presents the report indicative of the cost for the wire harness assembly 100. The user interface 110 is communicably coupled with the controller 106.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A system for calculating a cost for a wire harness assembly, the system comprising:
a controller configured to:
receive a computer generated three-dimensional (3D) model of the wire harness assembly for extracting a plurality of parameters from the three-dimensional model, the plurality of parameters being associated with a material of one or more components of the wire harness assembly, dimensions of the one or more components of the wire harness assembly, and a manufacturing process of the wire harness assembly;
analyze the plurality of parameters for determining the cost for the wire harness assembly; and
generate a report indicative of the cost for the wire harness assembly; and
a user interface communicably coupled with the controller, wherein the user interface receives and presents the report indicative of the cost for the wire harness assembly.

2. The system of claim 1, wherein the controller is further configured to extract the plurality of parameters from a list of materials associated with the computer generated 3D model of the wire harness assembly.

3. The system of claim 1, wherein the cost for the wire harness assembly includes a material cost, an operation cost, one or more overhead costs, a selling and administrative cost, and a profit.

4. The system of claim 1, wherein the one or more components include a connector, a wire, a braid, a ring terminal, a splice, and one or more accessories associated with the wire harness assembly.

5. The system of claim 4, wherein the controller is further configured to determine a weight of the braid for determining a cost associated with the braid of the wire harness assembly.

6. The system of claim 5, wherein the weight of the braid is determined based on a material of the braid and dimensions of the braid.

7. The system of claim 1, wherein the controller is further configured to analyze a plurality of wire harness assemblies for generating a consolidated list of materials associated with the plurality of wire harness assemblies.

8. The system of claim 7, wherein the consolidated list of materials is used for at least one of optimizing a design of one or more of the plurality of wire harness assemblies and assigning a supplier for procurement of materials for one or more of the plurality of wire harness assemblies.

9. The system of claim 1, wherein the controller is further configured to determine a type of machine required for manufacturing the wire harness assembly, a machine set-up time required for manufacturing the wire harness assembly, a time required for performing one or more operations for manufacturing the wire harness assembly, a sequence in which the one or more operations need to be performed for manufacturing the wire harness assembly, and a skill set required for performing the one or more operations.

10. The system of claim 1, wherein the controller is configured to determine the cost for the wire harness assembly for a plurality of countries based on a user input.

11. A method for calculating a cost for a wire harness assembly, the method comprising:
receiving, by a controller, a computer generated three-dimensional (3D) model of the wire harness assembly for extracting a plurality of parameters from the computer generated 3D model, the plurality of parameters being associated with a material of one or more components of the wire harness assembly, dimensions of the one or more components of the wire harness assembly, and a manufacturing process of the wire harness assembly;
analyzing, by the controller, the plurality of parameters for determining the cost for the wire harness assembly;
generating a report indicative of the cost for the wire harness assembly; and
presenting, by a user interface, the report indicative of the cost for the wire harness assembly, wherein the user interface is communicably coupled with the controller.

12. The method of claim 11 further comprising extracting, by the controller, the plurality of parameters from a list of materials associated with the computer generated 3D model of the wire harness assembly.

13. The method of claim 11 further comprising determining, by the controller, the cost for the wire harness assembly including a material cost, an operation cost, one or more overhead costs, a selling and administrative cost, and a profit.

14. The method of claim 11 further comprising determining, by the controller, the cost for the wire harness assembly including one or more of a connector, a wire, a braid, a ring terminal, a splice, and one or more accessories associated with the wire harness assembly.

15. The method of claim 14 further comprising determining, by the controller, a weight of the braid for determining a cost associated with the braid of the wire harness assembly, wherein the weight of the braid is determined based on a material of the braid and dimensions of the braid.

16. The method of claim 15 further comprising determining, by the controller, the weight of the braid based on a material of the braid and dimensions of the braid.

17. The method of claim 11 further comprising analyzing, by the controller, a plurality of wire harness assemblies for generating a consolidated list of materials associated with the plurality of wire harness assemblies.

18. The method of claim 17 further comprising optimizing a design of one or more of the plurality of wire harness assemblies and assigning a supplier for procurement of materials for one or more of the plurality of wire harness assemblies based on the generation of the consolidated list of materials.

19. The method of claim 11 further comprising determining, by the controller, a type of machine required for manufacturing the wire harness assembly, a machine set-up time required for manufacturing the wire harness assembly, a time required for performing one or more operations for manufacturing the wire harness assembly, a sequence in which the one or more operations need to be performed for manufacturing the wire harness assembly, and a skill set required for performing the one or more operations.

20. The method of claim 11 further comprising determining, by the controller, the cost for the wire harness assembly for a plurality of countries based on a user input.
